(19) United States
(12) Patent Application Publication
(10) Pub. No.: US 2008/0170014 A1
(43) Pub. Date: Jul. 17, 2008

(54) Organic light emitting display and method of correcting images thereof

(76) Inventors: Jin Woung Jung, Yongin-si (KR); Sun A Yang, Yongin-si (KR); Eun Jung Lee, Yongin-si (KR); Su Young Kim, Yongin-si (KR); Youn Chul Oh, Yongin-si (KR); Hye Hyang Park, Yongin-si (KR)

Correspondence Address: Robert E. Bushnell, Suite 300, 1522 K Street, N.W., Washington, DC, 20005-1202, US

(21) Appl. No.: 11/808,914

(22) Filed: Jun. 13, 2007

(30) Foreign Application Priority Data
Jan. 15, 2007 (KR) 10-2007-0004435

(51) Int. Cl. G09G 3/32

(52) U.S. Cl. 345/82

(57) ABSTRACT

An organic light emitting display and a method of correcting images thereof prevents the occurrence of excessive pixel aging, burning and image sticking caused by loading effect and includes: a loading effect measuring unit to measure a luminance according to a level at which an image signal having an equal gray scale value is loaded into a display panel of the organic light emitting display; an average loading level calculating unit to calculate a loading level at which the luminance averages; a loading effect compensating unit to compensate the power supply voltage corresponding to the image signal to obtain a luminance equal to the luminance at the average loading level; and a power supply control unit to control the power supply voltage to supply the compensated power supply voltage to the display panel of the organic light emitting display.

### CLAIM OF PRIORITY

This application makes reference to, incorporates the same herein, and claims all benefits accruing under 35 U.S.C. §119 from an application earlier filed in the Korean Intellectual Property Office on Jan. 15, 2007 and there duly assigned Serial No. 10-2007-0004435.

### BACKGROUND OF THE INVENTION

1. Field of the Invention

The present invention relates to an organic light emitting display and a method of correcting images thereof, and more particularly, the present invention relates to an organic light emitting display which prevents the occurrence of excessive pixel aging, burning and image sticking induced by a loading effect, and a method of correcting images thereof.

2. Discussion of Related Art

Organic light emitting displays are flat panel display devices, the display mechanism of which is based on the self-emitting property of organic light emitting diodes by which fluorescent or phosphorescent organic compounds are electrically excited to emit light. These organic light emitting displays have various advantages, such as high contrast ratio and excellent viewability due to the self-emitting property, high luminance, wide viewing angle approaching 180°, high-speed response so as to respond within a few μsec, thus attracting public attention as the next-generation flat panel display devices.

In the organic light emitting displays, an electric current (I_{OLED}) corresponding to a data voltage (V_{data}) that is supplied to a pixel circuit is supplied to an organic light emitting diode, and this organic light emitting diode emits light at a predetermined luminance in correspondence with the supplied current. However, such organic light emitting displays exhibit a phenomenon called a loading effect, in which as the number of light emitting pixel circuits (loading number) increases, the luminance per unit area (cd/m²) is decreased. In other words, the organic light emitting displays have a problem in that the luminance changes with the loading level of an image signal, and as a result, excessive pixel aging, burning or image sticking occurs.

This is explained as follows with reference to FIG. 1a and FIG. 1b.

As illustrated in FIG. 1a, an organic light emitting display exhibits a phenomenon in which the luminance is decreased with an increase in the loading level of an image signal, that is, the loading effect. For instance, the relative luminance measured when an image signal of an equal gray scale value induces light emission in 10% of the total display area, is detected to be higher than the relative luminance measured when the same image signal induces light emission in 100% of the total display area.

Furthermore, as illustrated in FIG. 1b, as the loading level of an image signal is increased, the luminance is reduced, and the power consumption is increased. This implies, conversely, that when the loading level of an image signal is decreased, the luminance is enhanced, and the power consumption is decreased.

As described above, organic light emitting displays have the loading effect, in which the luminance of the organic light emitting diode (in other words, the current flowing through the organic light emitting diode) is decreased with an increase in the loading level of an image signal. This loading effect causes excessive current to flow through a selected pixel circuit when, for example, the loading level is as low as about 1 to 20%, thereby causing excessive aging and burning of an organic light emitting diode or image sticking on the display screen. Thus, this loading effect 8 shortens the life span of organic light emitting displays, and also deteriorates the product reliability.

In order to address such problems, a method of correcting the luminance obtained with a low loading level of an image signal to the luminance obtained with a high loading level of an image signal, can be envisaged. However, such a method of correction has a problem in that the overall luminance of the displayed image is lowered, and thus, an additional correction process of generally increasing the luminance again so as to make a correction for the decrease in the overall luminance must be carried out. Accordingly, there is a risk that luminance distortion may be severe in the part of low gray scale values, which is undesirable.

In the meantime, in the organic light emitting display field, it is known that the aging, burning, deterioration of the luminescent material and characteristic (the mobility and threshold voltage) change of the pixel transistor generate the image sticking phenomenon. Of course, in the organic light emitting display as the result of this reason, the other image which is not desired image is outputted. And this is defined as the image sticking. For example, the image of the other color which is not image of the desired color is outputted. In addition, in the organic light emitting display field, the person skilled in the art recognizes the image sticking as the aging, burning, deterioration of the luminescent material.

### SUMMARY OF THE INVENTION

The present invention has been contrived to solve the problems described above, and an aspect of the present invention is to provide an organic light emitting display which can reduce a loading effect, thus preventing the occurrence of excessive pixel aging, burning and image sticking, and a method of correcting images thereof.

Another aspect of the present invention is to provide an organic light emitting display which does not exhibit luminance distortion in the region of low gray scale values even though the loading effect is reduced, and a method of correcting images thereof.

According to an aspect of the present invention to accomplish the aspects described above, an organic light emitting display is provided including: a loading effect measuring unit for measuring the loading effect by measuring the luminance according to the level at which an image signal having an equal gray scale value is loaded to the display panel of the organic light emitting display; an average loading level calculating unit for calculating a loading level at which the luminance averages; a loading effect compensating unit for compensating the power supply voltage corresponding to the image signal to have a luminance which is the same as the luminance at the average loading level; and a power supply control unit for controlling the power supply voltage to supply the compensated power supply voltage to the display panel of the organic light emitting display.

In the loading effect measuring unit, the luminance may be measured according to the level at which an image signal having an equal gray scale value, which is derived from an RGB digital image signal, is loaded to the display panel of the organic light emitting display.

The loading effect measuring unit may be electrically connected to an image processing unit where RGB analog image signals are converted to RGB digital image signals.

The average loading level calculating unit may add up all the loading levels of the image signal, and divide the added-up loading level by the number of the loading levels to calculate an average loading level.

The average loading level calculating unit may also add up all the luminance values corresponding to the respective loading levels of the image signal, and divide the added-up luminance value by the number of the loading levels to calculate an average luminance at the average loading level.

The loading effect compensating unit may effect compensation such that the power supply voltage to be supplied to the organic light emitting diode display panel is increased when the loading level of an image signal is lower than the average loading level, while the power supply voltage to be supplied to the organic light emitting diode display panel is decreased when the loading level of an image signal is higher than the average loading level.

The loading effect compensating unit may compensate the power supply voltage by referring to a compensation value lookup table in which compensation values have been calculated in advance according to the average loading level of an image signal and the power supply voltage, and saved.

The power supply control unit may be electrically connected to a power supply unit which supplies the compensated power supply voltage to the display panel of the organic light emitting display.

The power supply unit may be a DC-DC converter which is electrically connected to the organic light emitting diode display panel and which supplies an ELVDD power supply voltage and an ELVSS power supply voltage.

The power supply unit may compensate at least one of the ELVDD power supply voltage and the ELVSS power supply voltage that are supplied to the organic light emitting diode display panel, under the control of the power supply control unit.

According to another aspect of the present invention to accomplish the aspects described above, a method of correcting images of an organic light emitting display is provided, the method including: measuring the loading effect by measuring the luminance according to the level at which an image signal having an equal gray scale value is loaded to the display panel of the organic light emitting display; calculating an average loading level by calculating a loading level at which the luminance averages; compensating for the loading effect by compensating the power supply voltage corresponding to the image signal so as to obtain a luminance which is the same as the luminance at the average loading level; and controlling the power supply by controlling the power supply voltage to supply the compensated power supply voltage to the display panel of the organic light emitting display.

According to the method of correcting images of the organic light emitting display of the present invention as described above, when the loading level of an image signal to be displayed is lower than the average loading level, the power supply voltage to be supplied to the display panel of the organic light emitting diode display panel is increased, whereas when the loading level of an image signal to be displayed is higher than the average loading level, the power supply voltage to be supplied to the display panel of the organic light emitting diode display panel is decreased. Consequently, the occurrence of the loading effect in which the luminance is decreased as the loading level of an image signal is increased, or the luminance is increased as the loading level of an image signal is decreased, is reduced.

According to the present invention as described above, by reducing the occurrence of the loading effect, the occurrence of excessive aging, burning of organic light emitting diodes and image sticking, both being induced by the loading effect, can also be reduced.

Furthermore, according to the present invention as described above, by reducing the occurrence of excessive aging, burning of organic light emitting diodes or image sticking, the life span of the organic light emitting display can be increased, and the reliability of the device can also be improved.

Moreover, according to the present invention as described above, even though the loading effect is reduced, the phenomenon of luminance distortion in the region of low gray scale values does not occur.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1a is a conceptual diagram of changes in the luminance according to the loading level of an image signal having an equal gray scale value;

FIG. 1b is a graph of a phenomenon in which the luminance is reduced, while the power consumption is increased, as the loading level of image signals is increased in an organic light emitting display;

FIG. 2 is a flowchart of a method of correcting images using an organic light emitting display according to an embodiment of the present invention;

FIG. 3 is a graph of the concepts of the average loading level and the average luminance that are determined by the method of correcting images using the organic light emitting display according to an embodiment of the present invention;

FIG. 4 is an example of a compensation value lookup table for the organic light emitting display according to an embodiment of the present invention;

FIG. 5 is a block diagram of a configuration of an organic light emitting display according to an embodiment of the present invention;

FIG. 6a is a circuit diagram of an exemplary pixel circuit of the organic light emitting display according to an embodiment of the present invention; and

FIG. 6b is a driving timing diagram of the pixel circuit of FIG. 6a.

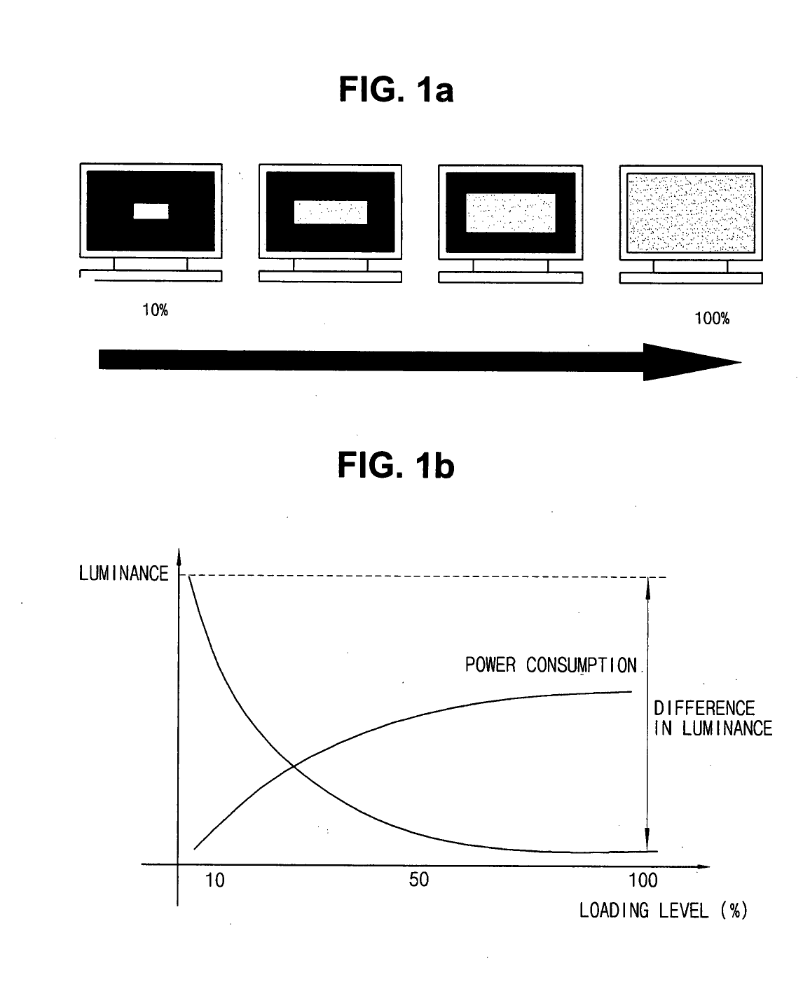

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as being limited to the embodiments set forth herein. Rather, these embodiments are provided so that this disclosure will be thorough and complete, and will fully convey the scope of the present invention.

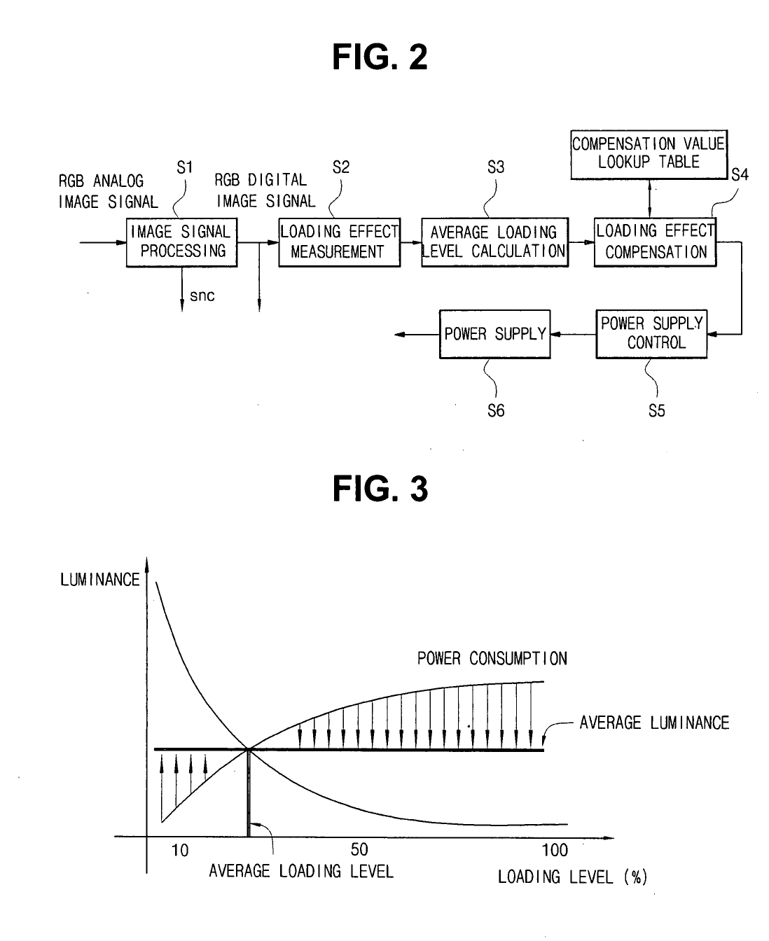

Referring to FIG. 2, a method of correcting images using an organic light emitting display according to an embodiment of the present invention is illustrated.

As illustrated in FIG. 2, the method of correcting images using the organic light emitting display according to the present invention includes the steps of processing an image signal (S1), measuring the loading effect (S2), calculating the average loading level (S3), compensating for the loading effect (S4), controlling the power supply (S5), and supplying the power (S6).

In the step of processing an image signal (S1), an RGB analog image signal supplied from an external source is sampled, and from the sampled signal, an RGB digital image signal and a synchronizing signal (snc), each having a predetermined bit length, are separated and outputted. As will be described later, the synchronizing signal is inputted to a clock signal supplying unit, while the RGB digital image signal is inputted to a gamma compensating unit or a data driving unit.

In the step of measuring the loading effect (S2), the luminance is measured according to the level at which an image signal having an equal gray scale value is loaded to the display panel of the organic light emitting display. That is, in the step of measuring the loading effect, the luminance is measured according to the level at which an image signal having an equal gray scale value, which is derived from an RGB digital image signal, is loaded to the display panel of the organic light emitting display. Conventionally, when the level at which the image signal having an equal gray scale value is loaded to the display panel is increased, the luminance is gradually decreased, owing to the loading effect. Thus, in the present invention, the luminance resulting from the loading effect is first determined so as to compensate for the luminance as described above.

In the step of calculating the average loading level (S3), loading levels are set in accordance with the loading levels of the image to be loaded into the display panel, and then the total loading level is divided by the total number of loading levels to determine an average loading level. In addition, at the same time, the luminance values corresponding to the respective loading levels 11 are all added up, and this total luminance value is divided by the total number of loading levels to calculate an average luminance at the average loading level as described above.

In the step of compensating for the loading effect (S4), the power supply voltage corresponding to the RGB digital image signal is compensated for to obtain a luminance which is the same as the average luminance calculated at the average loading level. For example, when the loading level of an image signal is lower than the average loading level, a compensation which increases the power supply voltage is performed so as to obtain a luminance value which is the same as the average luminance value at the average loading level. Also, when the loading level of an image signal is higher than the average loading level, a compensation which decreases the power supply voltage is performed so as to obtain a luminance value which is the same as the average luminance value at the average loading level.

As a matter of course, in this step of compensating for the loading effect, the power supply voltage is compensated for by referring to a compensation value lookup table in which compensation values have been calculated and saved in advance in accordance with the average loading level of the image signal and the power supply voltage.

As such, according to the present invention, an image is always outputted at a constant luminance, regardless of the loading level of the image signal, and thus, neither the phenomenon of loading effect nor the phenomenon of luminance distortion in the region of low gray scale values occurs.

In the step of controlling the power supply (S5), the power supply voltage is controlled to supply a compensated power supply voltage as described above to the display panel of the organic light emitting display. This step of controlling the power supply can be substantially achieved by a driver integrated circuit (driver IC) or a Pulse Width Modulation Integrated Circuit (PWM IC), each having a microcomputer. That is, the target compensated power supply voltage is set after the information of the compensated power supply voltage determined by the driver IC or the PWM IC at the step of compensating for the loading effect, is inputted.

In the step of supplying the power (S6), the compensated power supply voltage is supplied to the display panel of the organic light emitting display. This step of supplying the power can be substantially achieved by a DC-DC converter. That is, the DC-DC converter supplies a compensated ELVDD power supply voltage (the voltage supplied to the anode of an organic light emitting diode) or a compensated ELVSS power supply voltage (the voltage supplied to the cathode of an organic light emitting diode) to the organic light emitting diode display panel. As a matter of course, when the ELVDD power supply voltage or the ELVSS power supply voltage as such is supplied to each pixel circuit formed in the organic light emitting diode display panel, light having the average luminance at the average loading level, which corresponds to the data voltage and which is desired as well, is outputted.

Referring to FIG. 3, a graph of the concepts of the average loading level and the average luminance used in the method of correcting images using the organic light emitting display according to an embodiment of the present invention is illustrated.

As illustrated in FIG. 3, the present invention is intended to increase or decrease the voltage to obtain a constant luminance value, on the basis of the average loading level and the average luminance. In other words, the present invention compensates the power supply voltage (ELVDD voltage or ELVSS voltage) to be supplied to the display panel of the organic light emitting display, so as to obtain a constant luminance value, on the basis of the average loading level and the average luminance.

For instance, according to the present invention, when the loading level of an image signal is lower than the average loading level, a compensation which increases the power supply voltage is performed to obtain a luminance value which is the same as the average luminance value at the average loading level. On the other hand, when the loading level of an image signal is higher than the average loading level, a compensation which decreases the power supply voltage is performed to obtain a luminance value which is the same as the average luminance value at the average loading level.

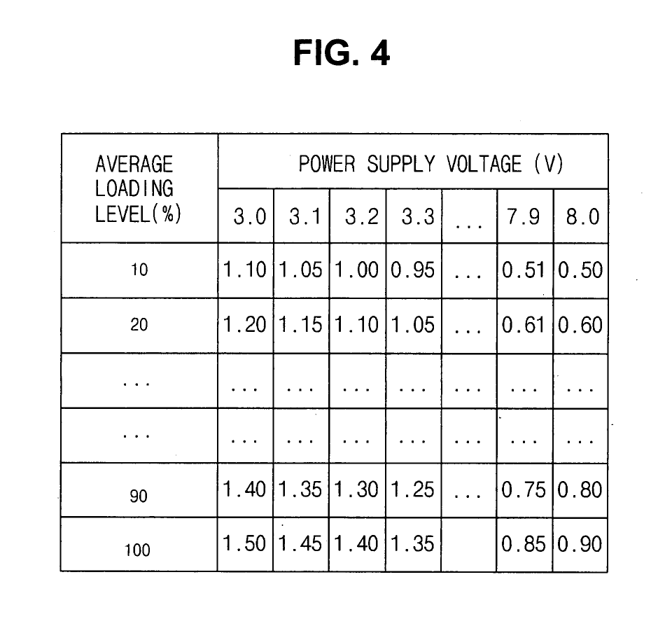

FIG. 4 is an example of the compensation value lookup table for the organic light emitting display according to an embodiment of the present invention.

As shown in FIG. 4, the uppermost row indicates a series of power supply voltage values, while the leftmost column indicates a series of average loading level values. At the crossing points of the power supply voltage values and the average loading level values, the compensation values that are calculated on the basis of actual measurement of luminance or calculated by interpolation are presented. Of course, the power supply voltage values in the uppermost row and the average loading level values in the leftmost column may be given in a range with a smaller increment; however, it should be noted that in this specification, the power supply voltage values are given with an increment of 0.1 V, and the average loading level values are given with an increment of 10%, for convenience of understanding.

As described above, this compensation value lookup table can be used in the step of compensating for the loading effect (S4). Thus, in the step of compensating for the loading effect (S4), a compensation value in accordance with the average loading level and the power supply voltage is called up, and the power supply is then compensated using this called-up compensation value. In other words, computation is first performed using the original, uncompensated power supply voltage value, based on the compensation value obtained from the compensation value lookup table and a predetermined operator, and then the power supply voltage to be supplied to the organic light emitting diode display panel is compensated in accordance with the loading level of the image signal.

In other words, when the loading level of an image signal is lower than the average loading level, the power supply voltage to be supplied to the organic light emitting diode display panel is increased to obtain a luminance value which is the same as the average luminance value at the average loading level, based on the compensation value as described above. Also, when the loading level of an image signal is higher than the average loading level, the power supply voltage to be supplied to the organic light emitting diode display panel is decreased to obtain a luminance value which is the same as the average luminance value at the average loading level, based on the compensation value as described above.

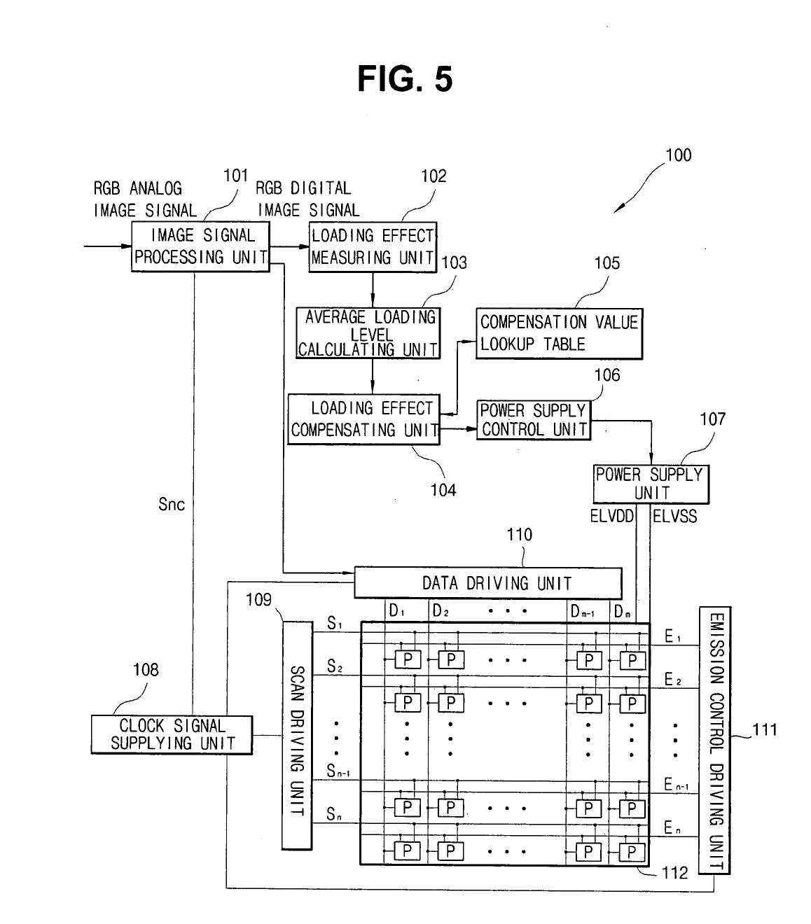

FIG. 5 is a block diagram of a configuration of an organic light emitting display 100 according to an embodiment of the present invention.

As illustrated in FIG. 5, the organic light emitting display 100 according to the present invention includes an image signal processing unit 101, a loading effect measuring unit 102, an average loading level calculating unit 103, a loading effect compensating unit 104, a compensation value lookup table 105, a power supply control unit 106, a power supply unit 107, a clock signal supplying unit 108, a scan driving unit 109, a data driving unit 110, an emission control driving unit 111, and an organic light emitting diode display panel 112.

In the image signal processing unit 101, an RGB analog image signal supplied from an external source is sampled, and from the sample signal, an RGB digital image signal and a synchronizing signal (snc), each having a predetermined bit length, are separated and outputted. The RGB digital image signal is inputted to the loading effect measuring unit 102 and the data driving unit 110, which are described below, while the synchronizing signal is inputted to the clock signal supplying unit 108. Furthermore, the RGB digital image signal may be optionally inputted to a gamma compensation unit, (not illustrated in FIG. 5), and then transmitted to the data driving unit 110.

The loading effect measuring unit 102 measures the luminance according to the level at which an image signal having equal gray scale value is loaded to the organic light emitting diode display panel 112. That is, the loading effect measuring unit 102 measures the luminance according to the level at which an image signal having an equal gray scale value, which is derived from the RGB digital image signal, is loaded to the organic light emitting diode display panel 112.

The average loading level calculating unit 103 determines loading levels on the basis of the loading level of the images loaded into the display panel, and then divides the total loading level by the total number of loading levels to determine an average loading level. In addition, at the same time, the luminance values corresponding to the respective loading levels are all added up, and this total luminance value is divided by the total number of loading levels to calculate an average luminance.

The loading effect compensating unit 104 performs compensation of the power supply unit corresponding to the RGB digital image signal so as to obtain a luminance value which is the same as the average luminance value corresponding to the average loading level. For example, when the loading level of an image signal is lower than the average loading level, a compensation which increases the power supply voltage is performed to obtain a luminance value which is the same as the average luminance value at the average loading level. Also, when the loading level of an image signal is higher than the average loading level, a compensation which decreases the power supply voltage is performed to obtain a luminance value which is the same as the average luminance value at the average loading level.

The compensation value lookup table 105 provides compensation values with respect to the average loading level and the power supply voltage, to the loading effect compensating unit 104, so that the loading effect compensating unit 104 performs a precise compensation of the power supply voltage. For this purpose, compensation values corresponding to the average loading level and the power supply voltage, which have been actually measured in advance or calculated by interpolation, are stored in the compensation value lookup table 105. This compensation value lookup table 105 may be, for example, a Programmable Read Only Memory (PROM), an Erasable PROM (EPROM), an Electrically Erasable PROM (EEPROM), a flash memory or equivalents thereof. However, the type of memory for the compensation value lookup table 105 is not limited to these examples.

The power supply control unit 106 controls the power supply voltage so as to actually supply the compensated power supply voltage as described above to the organic light emitting diode display panel 112. This power supply control unit 106 can achieve the power supply control by a driver IC or a PWM IC, each having a microcomputer. That is, the driver IC or the PWM IC sets the target compensated power supply voltage.

The power supply unit 107 supplies the compensated power supply voltage to the organic light emitting diode display panel 112. This power supply unit 107 can be a DC-DC converter. That is, the DC-DC converter supplies a compensated ELVDD power supply voltage or a compensated ELVSS power supply voltage to the organic light emitting diode display panel 112. When the ELVDD power supply voltage and ELVSS power supply voltage are supplied to each of the pixels formed in the organic light emitting diode display panel 112, light having the average luminance at the average loading level, which corresponds to the data voltage and which is desired as well, is outputted by the pixels.

The clock signal supplying unit 108 distributes or rearranges the reference clock signal using the synchronizing signal (snc) supplied by the image signal processing unit 101, to supply the reference clock signal to the scan driving unit 109, the data driving unit 110 and the emission control driving unit 111.

The scan driving unit 109 supplies scan signals sequentially to the organic light emitting diode display panel 112 via a number of scan lines (S1, . . . , Sn). That is, the scan driving unit 109 transmits sequential scan signals to the scan lines (S1, . . . , Sn) using the supplied clock signal.

The data driving unit 110 supplies data signals to the organic light emitting diode display panel 112 via a number of data lines (D1, . . . , Dm). That is, the data driving unit 110 sequentially samples the image signals supplied by the image signal processing unit 101, shifts the image signals, and maintains the image data of one horizontal line. Thereafter, the data driving unit 110 latches the maintained image data of one horizontal line, and generates data signals corresponding to the respective gray scale values of the image data to supply the generated data signals to the data lines according to a predetermined timing.

The emission control driving unit 111 sequentially supplies emission signals to the organic light emitting diode display panel 112 via a number of emission control lines (E1 . . . , En). That is, the emission control driving unit 111 controls the duration of the current flowing through an organic light emitting diode, thereby controlling the luminance of the organic light emitting diode.

The organic light emitting diode display panel 112 includes a number of scan lines (S1, . . . , Sn) and a number of emission control lines (E1, . . . , En), which are arranged in the vertical direction, and a number of data lines (D1, . . . , Dm) arranged in the horizontal direction, as well as pixel circuits defined by the scan lines (S1, . . . , Sn), emission control lines (E1, . . . , En), and data lines (D1, . . . , Dm).

The pixel circuit may be formed in a pixel region defined by two adjacent scan lines (or emission control lines) and two adjacent data lines. As described above, the scan lines (S1, . . . , Sn) may be supplied with scan signals from the scan driving unit 109, the data lines (D1, . . . , Dm) may be supplied with data signals from the data driving unit 110, and the emission control lines (E1, . . . , En) may be supplied with emission control signals from the emission control driving unit 111.

The image signal processing unit 101, the loading effect measuring unit 102, the average loading level calculating unit 103, the loading effect compensating unit 104, the power supply control unit 106, the power supply unit 107, the clock signal supplying unit 108, the scan driving unit 109, the data driving unit 110, the emission control driving unit 111 and the organic light emitting diode display panel 112 depicted in FIG. 5 may be all formed on one substrate. In particular, the image signal processing unit 101, the loading effect measuring unit 102, the average loading level calculating unit 103, the loading effect compensating unit 104, the power supply control unit 106, the power supply unit 107, the clock signal supplying unit 108, the scan driving unit 109, the data driving unit 110 and the emission control driving unit 111 may be formed on one substrate in the form of an integrated circuit. Moreover, the image signal processing unit 101, the loading effect measuring unit 102, the average loading level calculating unit 103, the loading effect compensating unit 104, the power supply control unit 106, the power supply unit 107, the clock signal supplying unit 108, the scan driving unit 109, the data driving unit 110 and the emission control driving unit 111 may also be formed in the same layer as the layer where the scan lines (S1, . . . , Sn), the data lines (D1, . . . , Dm), the emission control lines (E1, . . . , En) and the transistors of the pixel circuits (not shown in FIG. 5) are formed. Alternatively, the image signal processing unit 101, the loading effect measuring unit 102, the average loading level calculating unit 103, the loading effect compensating unit 104, the power supply control unit 106, the power supply unit 107, the clock signal supplying unit 108, the scan driving unit 109, the data driving unit 110 and the emission control driving unit 111 may also be formed on a separate substrate different from the substrate where the organic light emitting diode display panel 112 is formed, and the two substrates may be electrically connected. In addition, the image signal processing unit 101, the loading effect measuring unit 102, the average loading level calculating unit 103, the loading effect compensating unit 104, the power supply control unit 106, the power supply unit 107, the clock signal supplying unit 108, the scan driving unit 109, the data driving unit 110 and the emission control driving unit 111 may be formed in any one form selected from a Tape Carrier Package (TCP), a Flexible Printed Circuit (FPC), Tape Automatic Bonding (TAB), a Chip on Glass (COG) or equivalents thereof, which are electrically connected to the substrate where the organic light emitting diode display panel 112 is formed. However, the present invention is not limited thereto.

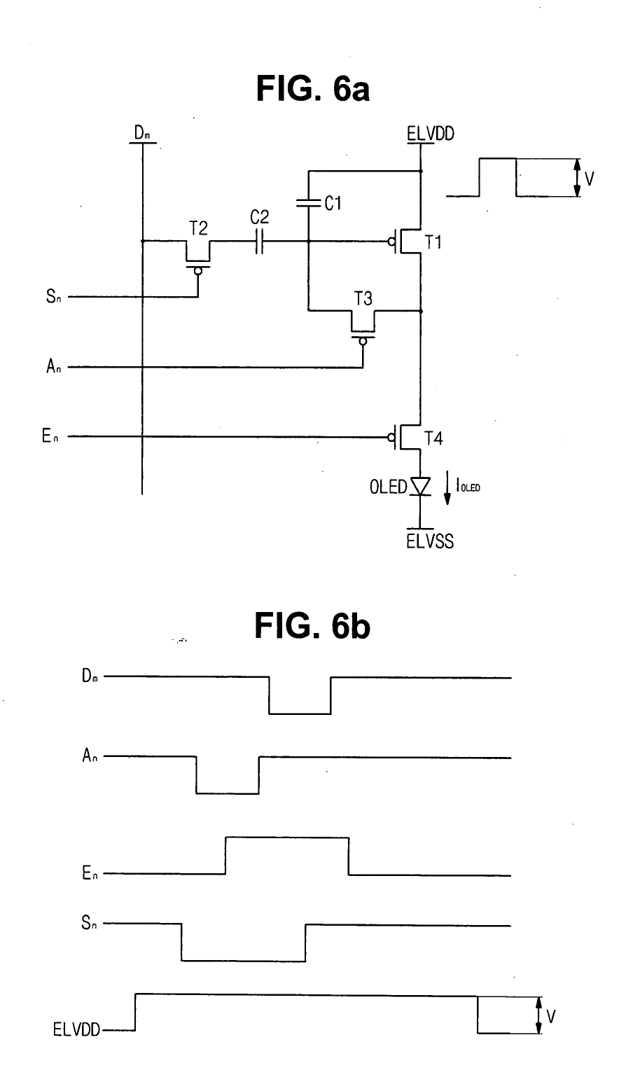

FIG. 6a is a circuit diagram of an exemplary pixel circuit formed in the organic light emitting diode display panel shown in the block diagram of FIG. 5, and FIG. 6b is a driving timing diagram of the pixel circuit of FIG. 6a.

As illustrated in FIG. 6a, a pixel circuit includes a scan line Sn supplying scan signals, a data line Dm supplying data signals, an auto-zero line An supplying auto-zero signals, an emission control line En supplying emission control signals, a first power supply voltage line ELVDD supplying a first power supply voltage, a second power supply voltage line ELVSS supplying a second power supply voltage, first to fourth transistors T1, T2, T3 and T4, first and second storage elements C1 and C2, and an Organic Light Emitting Diode (OLED).

The first power supply voltage line ELVDD and the second power supply voltage line ELVSS are electrically connected to the power supply unit 107, the scan line Sn to the scan driving unit 109, the data line Dm to the data driving unit 110, and the emission control line En to the emission control driving unit 111. The auto-zero line An is also electrically connected to the emission control driving unit 111, or may be electrically connected to another separate driving unit.

In the pixel circuit described above, when an auto-zero signal of low level is supplied by the auto-zero line An to the control electrode of the third transistor T3, the third transistor T3 is turned on. Subsequently, when an emission signal of high level is supplied by the emission control line En to the control electrode of the fourth transistor T4, the fourth transistor T4 is turned off. Then, the first transistor T1 is connected to the first storage element C1 in a diode configuration, so that the threshold voltage of the first transistor T1 is stored in the first storage element C1. When the auto-zero signal is raised to a high level, and subsequently a data voltage corresponding to the gray scale value that is intended to be displayed is supplied from the data line Dm, a data voltage resulting from the compensation of the threshold voltage by the coupling of the first storage element C1 and the second storage element C2, is supplied to a control electrode of the first transistor T1. Subsequently, when the emission signal is reduced to a low level, a current from the first power supply voltage line ELVDD flows to the organic light emitting diode OLED via the first transistor T1 which controls the current in response to the data voltage, thus light emission being effected.

The loading effect compensating unit 104 of FIG. 5 supplies data to the power supply control unit 106 on the compensated power supply voltage. Then, the power supply control unit 106 controls the power supply unit 107 to output the compensated power supply voltage.

Thus, eventually, the power supply unit 107 compensates the power supply voltage supplied to the organic light emitting diode display panel 112 (e.g., ELVDD) to be increased when the loading level of the image signal is lower than the average loading level, and compensates the power supply voltage supplied to the organic light emitting diode display panel 112 (e.g., ELVDD) to be decreased when the loading level of the image signal is higher than the average loading level.

Therefore, as illustrated in FIG. 6a and FIG. 6b, the current flowing through the organic light emitting diode OLED (I_{OLED}) can be substantially controlled by, for example, changing the voltage V of the first power supply voltage ELVDD. Then, when the loading level of an image signal is lower than the average loading level, the power supply voltage supplied to the organic light emitting diode display panel 112 (e.g., the ELVDD voltage) is increased, while when the loading level of an image signal is higher than the average loading level, the power supply voltage supplied to the organic light emitting diode display panel (e.g., the ELVDD voltage) is relative decreased, thereby the occurrence of the loading effect being prevented.

As discussed above, the organic light emitting display and the method of correcting images thereof according to the present invention reduces the occurrence of the so-called loading effect, in which the luminance is decreased with an increase in the loading level of the signal of an image to be displayed, or the luminance is increased with a decrease in the loading level of the image signal, by increasing the power supply voltage supplied to the organic light emitting diode display panel when the loading level of the image signal is lower than the average loading level, or by decreasing the power supply voltage supplied to the organic light emitting diode display panel when the loading level of the image signal is higher than the average loading level.

As such, the present invention is effective in reducing the occurrence of the loading effect, thereby reducing the occurrence of excessive pixel aging, burning or image sticking of the organic light emitting diode resulting therefrom.

Furthermore, since the occurrence of excessive pixel aging, burning or image sticking of the organic light emitting diode is reduced as described above, the life span of the organic light emitting display is increased, and the reliability of the device is also improved.

Moreover, according to the present invention, even though the loading effect is reduced as described above, the phenomenon of luminance distortion in the region of low gray scale values does not occur.

Described and illustrated above are embodiments of the organic light emitting display and the method of correcting images thereof according to the present invention. However, the present invention is not intended to be limited thereto. It should be understood that various modifications and variations of the present invention can be made thereto by those skilled in the art without departing from the spirit and the technical scope of the present invention as defined by the appended claims.

What is claimed is:

1. An organic light emitting display comprising:
a loading effect measuring unit to measure the luminance according to a level at which an image signal having an equal gray scale value is loaded into a display panel of the organic light emitting display;
an average loading level calculating unit to calculate an average loading level at which the luminance averages;
a loading effect compensating unit to compensate for the loading effect by compensating a power supply voltage corresponding to the image signal to obtain a luminance equal to a luminance for the average loading level; and
a power supply control unit to control the power supply voltage to supply the compensated power supply voltage to the display panel of the organic light emitting display.

2. The organic light emitting display according to claim 1, wherein the loading effect measuring unit measures the luminance according to the level at which an image signal having an equal gray scale value, derived from an RGB digital image signal, is loaded into the display panel of the organic light emitting display.

3. The organic light emitting display according to claim 1, wherein the loading effect measuring unit is electrically connected to an image processing unit to convert an RGB analog image signal into an RGB digital image signal.

4. The organic light emitting display according to claim 1, wherein the average loading level calculating unit adds up all of the loading levels of the image signal, and divides the total loading level by the number of loading levels to calculate an average loading level.

5. The organic light emitting display according to claim 4, wherein the average loading level calculating unit adds up all of the luminance values according to the respective loading levels of the image signal, and divides the total luminance value by the number of loading levels to calculate an average luminance value at an average loading level.

6. The organic light emitting display according to claim 1, wherein the loading effect compensating unit effects compensation such that upon the loading level of an image signal being lower than the average loading level, the power supply voltage supplied to the display panel of the organic light emitting display is increased, while upon the loading level of an image signal being higher than the average loading level, the power supply voltage supplied to the display panel of the organic light emitting display is decreased.

7. The organic light emitting display according to claim 1, wherein the loading effect compensating unit effects compensation of the power supply voltage by referencing a compensation value lookup table in which compensation values of the image signal have been calculated in advance and stored according to the average loading level and the power supply voltage.

8. The organic light emitting display according to claim 1, wherein the power supply control unit is electrically connected to a power supply unit to supply the compensated power supply voltage to the display panel of the organic light emitting display.

9. The organic light emitting display according to claim 8, wherein the power supply unit is electrically connected to the display panel of the organic light emitting display, and wherein the power supply unit comprises a DC-DC converter to supply an ELVDD power supply voltage and an ELVSS power supply voltage.

10. The organic light emitting display according to claim 9, wherein the power supply unit compensates at least one of the ELVDD power supply voltage and the ELVSS power supply voltage supplied to the display panel of the organic light emitting display, under the control of the power supply control unit.

11. A method of correcting images of an organic light emitting display, the method comprising:
measuring the loading effect by measuring the luminance according to a level at which an image signal having an equal gray scale value is loaded into a display panel of the organic light emitting display;
calculating an average loading level by calculating an average loading level at which the luminance averages;
compensating for the loading effect by compensating the power supply voltage corresponding to the image signal to obtain a luminance equal to the luminance at the average loading level; and
controlling the power supply by controlling the power supply voltage to supply the compensated power supply voltage to the display panel of the organic light emitting display.

12. The method according to claim 11, wherein, in measuring the loading effect, the luminance is measured according to a level at which an image signal having an equal gray scale value, derived from an RGB digital image signal, is loaded into the display panel of the organic light emitting display.

13. The method according to claim 11, wherein measuring the loading effect is performed after processing images by converting an RGB analog image signal into an RGB digital image signal.

14. The method according to claim 11, wherein, in calculating an average loading level, the loading levels of the image signal are all added up, and the added-up loading level is divided by the number of loading levels to calculate an average loading level.

15. The method according to claim 14, wherein, in calculating an average loading level, the luminance values of the respective loading levels of the image signal are all added up, and the added-up luminance value is divided by the number of loading levels to calculate an average luminance at the average loading level.

16. The method according to claim 11, wherein, in compensating for the loading effect, upon the loading level of an image signal being lower than the average loading level, the power supply voltage supplied to the display panel of the organic light emitting display is compensated by being increased, while upon the loading level of an image signal being higher than the average loading level, the power supply voltage supplied to the display panel of the organic light emitting display is compensated by being decreased.

17. The method according to claim 11, wherein, in compensating for the loading effect, the compensation of the power supply voltage is achieved by referencing a compensation value lookup table in which compensation values have been calculated in advance according to the average loading level of the image signal and the power supply voltage, and saved.

18. The method according to claim 11, wherein controlling the power supply is followed by supplying the compensated power supply voltage to the display panel of the organic light emitting display.

19. The method according to claim 18, wherein supplying the compensated power supply voltage is performed by a DC-DC converter electrically connected to the display panel of the organic light emitting display, and wherein the DC-DC converter supplies an ELVDD power supply voltage and an ELVSS power supply voltage.

20. The method according to claim 19, wherein, in supplying the compensated power supply voltage, at least one of the ELVDD power supply voltage and the ELVSS power supply voltage supplied to the display panel of the organic light emitting display, is compensated under the control of the power supply control unit of the organic light emitting display.
